(19) United States
(12) Patent Application Publication
(10) Pub. No.: US 2005/0208784 A1
(43) Pub. Date: Sep. 22, 2005

(54) Tool-less mounting device for interface card

(75) Inventor: Lin-Wei Chang, Taipei (TW)

Correspondence Address: BRUCE H. TROXELL, SUITE 1404, 5205 LEESBURG PIKE, FALLS CHURCH, VA, 22041, US

(73) Assignee: Inventec Corporation

(21) Appl. No.: 10/895,059

(22) Filed: Jul. 21, 2004

(30) Foreign Application Priority Data
Mar. 19, 2004 (TW) 93204153

(51) Int. Cl. H01R 13/42

(52) U.S. Cl. 439/64

(57) ABSTRACT

A tool-less mounting device for an interface card including an interface holder, an interface card, a first fixed bracket and a second fixed bracket. The interface holder has a first positioning point and a second positioning point. The interface card has a first positioning hole and a second positioning hole. The first fixed bracket and the second fixed bracket are located on the interface holder, and individually driven between a first position and a second position. When the interface card is mounted onto the interface holder, the first positioning point and the second positioning point are embedded respectively into the first positioning hole and second positioning hole, and the first fixed bracket and the second fixed bracket are disposed respectively at the second position; and when the interface card is removed form the interface holder, the first positioning point and the second positioning point are separated respectively from the first positioning hole and the second positioning hole, and the first fixed bracket and the second fixed bracket individually resume the first position.

### 1. FIELD OF THE INVENTION

The present invention relates to a mounting device for interface card, and more particularly to a tool-less mounting device for interface card being used in a computer server without requiring any tool to install the interface card in the computer server, that is capable of facilitating the stacking of computer servers and establishing a standard interface specification.

### 2. BACKGREVOLUTION OF THE INVENTION

At present, all methods of mounting an interface card onto a computer adopt screws for the mounting, and thus if the area of the interface card is too large, then it may take three to four screws instead of one screw for the fixture, which will make the assembling more complicated.

As disclosed in the U.S. Pat. No. 5,513,329, since the interface card is a larger one, therefore it is necessary to use three screws to mount the interface card securely onto the retaining frame of the computer.

Thus, the key point of this invention is to design an tool-less mounting device for interface card capable of simplifying the installation procedure of the interface card and enhancing the secure installation of the interface card in order to achieve the cost-saving and quick installation objectives.

In view of the description above, the conventional methods of mounting a computer interface card at least have the following shortcomings:
1. The conventional method requires tools such as a screwdriver to install the interface card in the computer, which is not a friend humanistic design because users cannot install or remove the interface card without a tool.
2. The conventional way of mounting an interface card is more complicated, and thus increasing the level of complexity and difficulty for the installation and reducing the speed of the installation, which affects the automated operation flow.
3. For the conventional method, rust occurs easily at the screwed connection or damages to the interface card occur if an excessive force is exerted while mounting the interface card.
4. When the conventional method is used in computer servers, it will affect the stacking of the computer servers, and the standard specification cannot be established.

### SUMMARY OF THE INVENTION

In view of the shortcomings of the prior art, it is the primary object of the present invention to provide an tool-less mounting device for interface card without requiring any accessory tool to mount an interface card into a computer, and such humanistic design allows users not to worry about the problem of having no tools at hand for the installation or removal of the interface card.

The secondary object of the present invention is to provide an tool-less mounting device for interface card by simplifying the interface card mounting procedure and further reducing the level of complexity and difficulty of the installation and assembling as well as improving the assembling speed to facilitate the automated assembling operation flow.

Another object of the present invention is to provide an tool-less mounting device for interface card capable of effectively preventing the interface card from being damaged during its installation and securely mounting the same into a computer.

Yet, another object of the present invention is to provide an tool-less mounting device for interface card that facilitates the stacking of the computer servers and also establishes a standard specification for the interface card.

To achieve the foregoing objectives, the present invention provides an tool-less mounting device for interface card which comprises an interface holder, having a first positioning point and a second positioning point with an appropriate distance apart from each other; wherein the first positioning point further comprises a first head section and a first neck section being mutually coupled, and the radial width of the first head section is larger than that of the first neck section; the second positioning point further comprises a second head section and a second neck section, and the radial diameter of the second head section is larger than that of the second neck section; an interface card having a first positioning hole and a second positioning hole; wherein the first positioning hole further comprises a first entrance section and a first engaging section, and the first positioning point enters into the first entrance section of the first positioning hole, such that the first neck section of the first positioning point is engaged with the first engaging section of the first positioning hole; the second positioning hole further comprises a second entrance section and a second engaging section mutually coupled, and the second positioning point enters into the second entrance section of the second positioning hole, such that the second neck section of the second positioning point is engaged with the second engaging section of the second positioning hole; and at least one fixed bracket be in a disposed at the interface holder and pressing against one side of the interface card for securing the interface card.

### BRIEF DESCRIPTION OF THE DRAWINGS

FIG. 1 is a perspective view of the interface holder of a tool-less mounting device for interface card according to a preferred embodiment of the present invention.

FIG. 2 is a perspective view of the interface card of a tool-less mounting device for interface card according to a preferred embodiment of the present invention.

FIG. 3 is a perspective view of an interface card assembled with a tool-less mounting device for interface card according to a preferred embodiment of the present invention.

### DESCRIPTION OF THE PREFERRED EMBODIMENT

To make it easier for our examiner to understand the objective of the invention, its structure, innovative features, and performance, we use a preferred embodiment together with the attached drawings for the detailed description of the invention.

The tool-less mounting device for interface card according to a preferred embodiment of the present invention comprises an interface holder, an interface card and at least one fixed bracket.

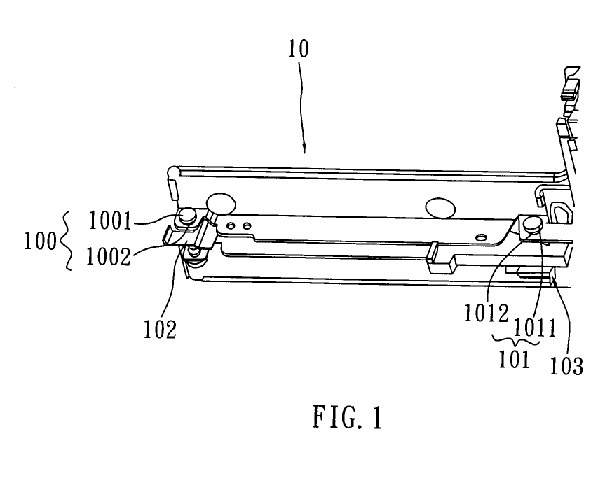

Please refer to FIGS. 1, 2 and 3 respectively for illustrative views of an interface holder 10, an interface card 20 and a mounted tool-less mounting device assembled with an interface card according to a preferred embodiment of the invention,

In FIG. 1, the interface holder 10 is a holder on a computer and has a first positioning point 100 and a second positioning point 101 with an appropriate distance apart, and the first positioning point 100 further comprises a first head section 1001 and a first neck section 1002 mutually coupled, and the radial width of the first head section 1001 is larger than that of the first neck section 1002; the second positioning point 101 further comprises a second head section 1011 and a second neck section 1012 mutually coupled, and the radial width of the second head section 1011 is larger than that of the second neck section 1012. Therefore, the first positioning point 100 and the second positioning point 101 have the shape of a mushroom as shown in the figures. Please refer to the figures for the first fixed bracket 102 and the second fixed bracket 103 being disposed on the interface holder 10, and the first fixed bracket 102 is driven between a first position and a second position, and the second fixed bracket 103 is disposed on the interface holder at a position corresponding to the first fixed bracket 102 and the second fixed bracket 103 is similar to the first fixed bracket 102 and driven between a first position and a second position

In FIG. 1, if the interface card is not mounted onto the interface holder 10, then the first fixed bracket 102 and the second fixed bracket 103 are disposed individually at their own first position.

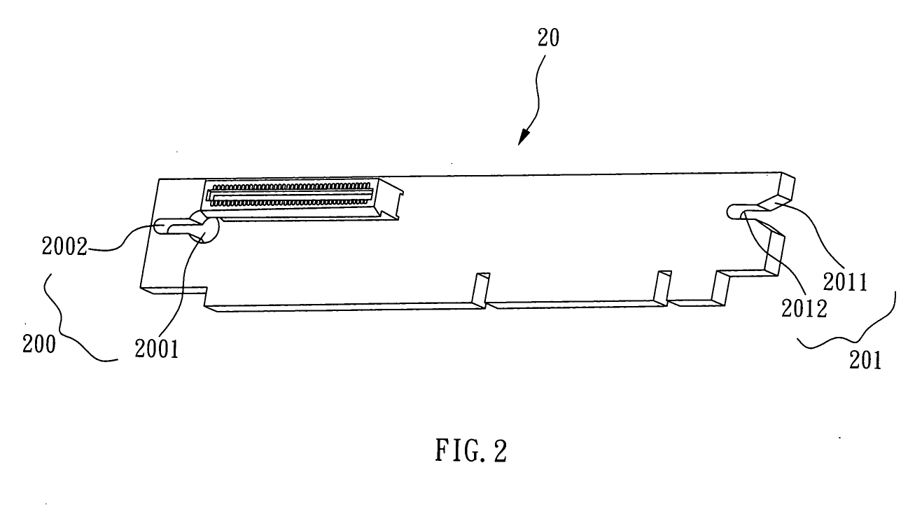

In FIG. 2, the interface card 20 has a first positioning hole 200 and a second positioning hole 201; wherein the first positioning hole 20 comprises a first entrance section 2001 and a first engaging section 2002 mutually coupled and the second positioning hole 201 comprises a second entrance section 2011 and a second engaging section 2012 mutually coupled;

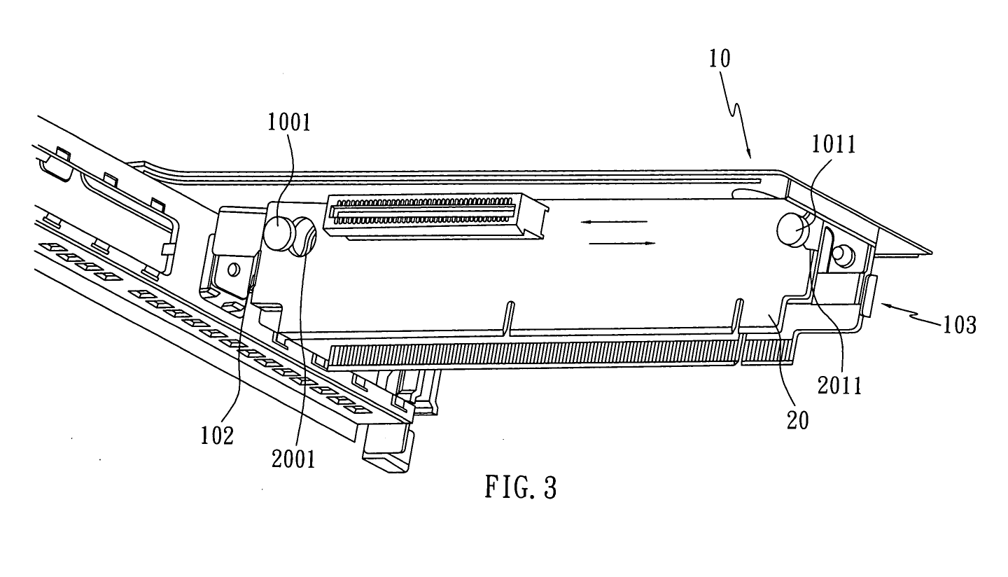

When the first positioning point 100 of the interface holder 110 as shown in FIG. 1 enters into the first entrance section 2001 of the first positioning hole 200, which refers to the first head section 1001 of the first positioning point 100 sliding after entering into the first entrance section 2001, the first neck section 1001 of the first positioning point 100 is engaged with the first engaging section 2002 of the first positioning hole 200. In the meantime, the second positioning point 101 enters into the second positioning hole 201, so that the second neck section 1012 of the second positioning point 101 is engaged with the second engaging section 2012 of the second positioning hole 201. In a word, when the interface card 20 is mounted onto the interface holder 10 as shown in FIG. 3, the first positioning point 100 and the second positioning point 101 are embedded respectively into the first positioning hole 200 and the second positioning hole 201. Then, the first fixed bracket 102 and the second fixed bracket 103 are disposed individually at their own second position and press against both sides of the interface card 20 for securing the interface card 20.

If it is necessary to separate the interface card 20 from the interface holder 10, the first fixed bracket 102 and the second fixed bracket 103 are pressed to separate the first positioning point 100 and the second positioning point 101 respectively from the first positioning hole 200 and the second positioning hole 201. Therefore, the forces exerted on first fixed bracket 102 and the second fixed bracket 103 are released, and the first fixed bracket 102 and the second fixed bracket 103 individually resume their original first position as shown in FIG. 1.

The tool-less interface mounting device according to a preferred embodiment of the present invention uses a first positioning hole 200 and a second positioning hole 201 disposed on the interface card 20 are latched into the first positioning point 100 and the second positioning point 101, and the first fixed bracket 102 and second fixed bracket 103 are secured to mount the interface card onto the interface holder 10. Of course, the distance between the first positioning hole 200 and the second positioning hole 201 of the interface card must be designed according to the corresponding distance between the first positioning point 100 and the second positioning point 101 of the interface card 20 in order to successfully secure the interface card 20 onto the interface holder 10, and the first positioning hole 200 and the second positioning hole 201 of the interface card 20 have the shape of a key.

In summation of the description above, the tool-less interface mounting device according to the present invention does not require any other tool to mount the computer interface card into the computer, and can effectively simplifying the installation procedure of the interface card, and further improves the installation speed and effectively prevent the interface card from being damage during the installation.

While the preferred embodiment of the invention has been set forth for the purpose of disclosure, modifications of the disclosed embodiment of the invention as well as other embodiments thereof may occur to those skilled in the art. For example, the quantity of fixed brackets is increased or decreased; and the shape of the positioning hole is changed, the shape of the positioning point is changed, etc. Accordingly, the appended claims are intended to cover all embodiments which do not depart from the spirit and scope of the invention.

1. A tool-less mounting device for an interface card, comprising:
a) an interface holder having a first positioning point and a second positioning point spaced apart a predetermined distance, wherein said first positioning point further comprises a first head section and a first neck section being mutually coupled and a radial width of said first head section being larger than that of said first neck section; and said second positioning point further comprises a second head section and a second neck section mutually coupled and the a radial width of said second head section being larger than that of said second neck section;
b) an interface card having a first positioning hole and a second positioning hole; wherein said first positioning hole further comprises a first entrance section and a first engaging section, said first positioning point entering into said first entrance section of said first positioning hole for enabling said first neck section of said first positioning point being engaged with said first engaging section of said first positioning hole, and said second positioning hole further comprises a second entrance section and a second engaging section being mutually coupled, and said second positioning point entering into said second entrance section of said second positioning hole for enabling said second neck section of said second positioning point being engaged with said second engaging section of said second positioning hole; and
c) at least one fixed bracket, bracket located on said interface holder and pressing against one side of said interface card securing said interface card thereto and being movable between a first position and a second position.
wherein the first engaging section is slidably inserted into the first neck section and the second engaging section is slidably inserted into the second neck section.

2. (canceled)

3. The tool-less mounting device according to claim 1, wherein said first positioning point and said second positioning point are in a shape of a mushroom.

4. The tool-less mounting device of according to claim 1, wherein said first positioning hole and said second positioning hole are in the a shape of a key.

5-7. (canceled)

8. The tool-less mounting device according to claim 11, wherein said first positioning point and said second positioning point are in a shape of a mushroom.

9. The tool-less mounting device according to claim 11, wherein said first positioning point and said second positioning point are in a shape of a key.

10. (canceled)

11. A tool-less mounting device for an interface card comprising:
a) an interface holder having:
i) a first positioning point;
ii) a second positioning point spaced apart from the first positioning point a predetermined distance;
iii) a first fixed bracket located on the interface holder; and
iv) a second fixed bracket located on the interface holder and spaced apart from the first fixed bracket, each of the first fixed bracket and the second fixed bracket is movable between a first position and a second position; and
b) an interface card removably connected to the interface holder and having a first positioning hole and a second positioning hole,
wherein, when the interface card is removed from the interface holder, the first positioning point is separated from the first positioning hole, the second positioning point is separated from the second positioning hole, and the first fixed bracket and the second fixed bracket are located in the first position, and, when the interface card is connected to the interface holder, the first positioning point is located in the first positioning hole, the second positioning point is located in the second positioning hole, and the first fixed bracket and the second fixed bracket are located in the second position.

12. The tool-less mounting device according to claim 11, wherein the first positioning hole having a first entrance section and a first engaging section, and the second positioning hole having a second entrance section and a second engaging section.

13. The tool-less mounting device according to claim 12, wherein the first positioning point having a first head section and a first neck section, and the second positioning point having a second head section and a second neck section.

14. The tool-less mounting device according to claim 13, wherein, when the interface card is connected to the interface holder, the first neck section is located in the first engaging section, and the second neck section is located in the second engaging section.
